(19) United States
(12) Patent Application Publication
(10) Pub. No.: US 2013/0223585 A1
(43) Pub. Date: Aug. 29, 2013

(54) X-RAY CT SYSTEM AND CONTROL PROGRAM

(71) Applicants: Kabushiki Kaisha Toshiba, (US); Toshiba Medical Systems Corporation, (US)

(72) Inventor: Shinsuke TSUKAGOSHI, Nasushiobara-shi (JP)

(73) Assignees: Toshiba Medical Systems Corporation, Otawara-shi (JP); Kabushiki Kaisha Toshiba, Tokyo (JP)

(21) Appl. No.: 13/768,490

(22) Filed: Feb. 15, 2013

(30) Foreign Application Priority Data
Feb. 24, 2012 (JP) 2012-038398

(51) Int. Cl. G01N 23/04

(52) U.S. Cl. CPC G01N 23/046
USPC 378/4

(57) ABSTRACT

The X-ray CT system and control program thereof according to the embodiment comprise an X-ray tube, a collimator, and a controller. The X-ray tube has an emission surface of X-rays and is configured such that the size of an effective focal spot that is the apparent size of the emission surface when the emission surface is observed from the side where X-rays are irradiated is made smaller at one end of a cone angle and the size of the effective focal spot is made increasingly larger at the other end of the cone angle. The controller is configured to select the effective focal spot with any size from small to large by controlling the collimator.

### CROSS-REFERENCE TO RELATED APPLICATION

This application is based upon and claims the benefit of priority from Japanese Patent Application No. 2012-038398, filed Feb. 24, 2012; the entire contents of which are incorporated herein by reference

### FIELD

The embodiment of the present invention pertains to an X-ray CT system and a control program thereof.

### BACKGROUND

Conventional X-ray CT (computer tomography) systems include those that acquire projection data by detecting X-rays irradiated onto a subject from an X-ray tube and transmitted through the subject with an X-ray detector, then reconstruct the images acquired from the projection data.

The X-ray tube has an anode with an emission surface for emitting X-rays and a cathode with a filament. X-rays having a cone angle are irradiated onto the subject such that they spread from an emission surface in the rostrocaudal direction of the subject. The size of an effective focal spot that is the apparent size of the emission surface when the emission surface is observed from the side where X-rays are irradiated is sometimes referred to as the focal spot size.

The focal spot size is different for the case in which the emission surface is observed from near the anode and for the case in which the emission surface is observed from near the cathode. The emission surface is configured such that the focal spot size is small near the anode side and made increasingly larger from the anode toward the cathode.

The X-ray detector has X-ray detecting elements arranged in the rostrocaudal direction and the horizontal 2-dimensional direction orthogonal to the rostrocaudal direction, comprising an equal type, a hybrid-type, and an unequal type of X-ray detector depending on the mode of arrangement.

In the X-ray detector of the equal type, the X-ray detecting elements are evenly arranged in the rostrocaudal direction of the subject. The size of the X-ray detecting element in the rostrocaudal direction is sometimes referred to as the detector size.

In the X-ray detector of the hybrid-type, on the center part in the rostrocaudal direction of the X-ray detector, a plurality of rows of X-ray detecting elements with a small detector size are arranged, and anterior or posterior thereto, X-ray detecting elements with a large detector size are arranged for every specific number of rows.

In the unequal type, the X-ray detecting elements are symmetrically arranged from a small detector size to a large detector size.

Further, when the X-rays emitted from a focal point of small focal spot size and transmitted through the subject are detected by the X-ray detecting elements of large detector size, high resolution cannot be obtained upon imaging; therefore, the X-ray detecting elements of small detector size cannot be sufficiently utilized. In the following description, the terms “high resolution,” “moderate resolution,” and “low resolution” are used in the order of highness of resolution; however, the level of resolution is relatively determined.

However, the X-ray detector of the equal type is problematic in that it is not effective to use the small detector size for all X-ray detecting elements of the X-ray detector in order to efficiently have high resolution upon imaging.

In addition, the X-ray detector of the hybrid-type is problematic in that the X-ray detecting elements arranged in the form of a plurality of rows with small detector size on the center part and focal points with small focal spot size do not always correspond, preventing the X-ray detecting elements of small detector size from being sufficiently utilized.

Further, similar to the hybrid-type thereof, the X-ray detector of the unequal type is also problematic in that the X-ray detecting elements with a small detector size cannot be sufficiently utilized.

Further, in the case of carrying out helical CT scanning with the X-ray CT using the X-ray detector of the hybrid-type or the X-ray detector of the unequal type, the following problems exist.

With helical CT scanning, the X-rays are irradiated from the X-ray tube onto the subject by rotating the X-ray detector and the X-ray tube oppositely arranged across the top on which the subject is mounted while moving the top in the rostrocaudal direction. When the focal point of small focal spot size and the X-ray detecting element of small detector size correspond with each other across the subject moved to the first position, based on the X-rays irradiated from the focal point of small focal spot size, transmitted through the subject and detected by the X-ray detecting element of small detector size, projection data with a high resolution is acquired. Further, when the focal point of large focal spot size and the X-ray detecting element of large detector size correspond with each other across the subject from the first position to the second position, based on the X-rays irradiated from the focal point of large focal spot size, transmitted through the subject and detected by the X-ray detecting element of large detector size, projection data with a low resolution is acquired.

In other words, with respect to the subject, projection data with a high resolution and projection data with a low resolution are acquired as mixed. Based on the projection data thus mixed, images with a high resolution cannot be reconstructed.

Accordingly, also from this point, a problem exists in that the X-ray detecting element of small detector size cannot be sufficiently utilized.

In addition, upon X-ray imaging, when the helical CT scanning is not carried out and the top is not moved in the rostrocaudal direction, the same problem exists.

### BRIEF DESCRIPTION OF THE DRAWINGS

FIG. 1 is a block diagram illustrating the configuration of an X-ray CT system according to the first embodiment.

FIG. 2 is a conceptual illustration of an X-ray tube.

FIG. 3 illustrates an X-ray detector having a small detection range at one end in the rostrocaudal direction.

FIG. 4 illustrates projection data to be obtained when imaged in each mode.

FIG. 5 illustrates X-ray detecting elements and projection data as corresponding with each other.

FIG. 6 illustrates an X-ray detector when it carries out a CT scan using detection region B.

FIG. 7 illustrates the X-ray detector when it carries out a CT scan using detection region C.

FIG. 8 illustrates the X-ray detector when it carries out a CT scan using detection region D.

FIG. 9 is a flow chart illustrating the operation of an X-ray CT system.

FIG. 10 is a flow chart illustrating the control of a collimator.

FIG. 11 is a flow chart illustrating a reconstruction.

FIG. 12 illustrates the X-ray detector of an equal type according to the comparative example.

FIG. 13 illustrates the X-ray detector of a hybrid-type according to the comparative example.

FIG. 14 illustrates the X-ray detector when CT scanning is started using all of detection regions A to D according to the second embodiment.

FIG. 15 illustrates the X-ray detector when CT scanning is ended.

FIG. 16 illustrates a CT scan in which X-rays are irradiated from the effective focal spot of small size according to the third embodiment.

FIG. 17 illustrates CT scanning in which X-rays are irradiated from an effective focal spot of large size.

FIG. 18 illustrates CT scanning in which X-rays are irradiated from an effective focal spot of small size according to the fourth embodiment,

FIG. 19 illustrates CT scanning in which X-rays are irradiated from an effective focal spot of large size.

### DETAILED DESCRIPTION

The X-ray CT system and control program thereof according to the present embodiment comprise an X-ray tube, an X-ray detector, a collimator, and a controller. The collimator limits the irradiation range of the X-rays for the subject. The controller limits the collimator. The X-ray tube has an emission surface for the X-rays and is configured such that the size of the effective focal spot that is the apparent size of the emission surface when the emission surface is observed from the side where X-rays are irradiated is made smaller at one end of a cone angle, and the size of the effective focal spot is made increasingly larger toward the other end of the cone angle. The controller is configured to select the effective focal spot at any size from small to large size by controlling the collimator.

Thereby, upon imaging, projection data with a high resolution can be effectively obtained, and further, the X-ray detecting elements of small detector size can be sufficiently utilized.

### Configuration

### First Embodiment

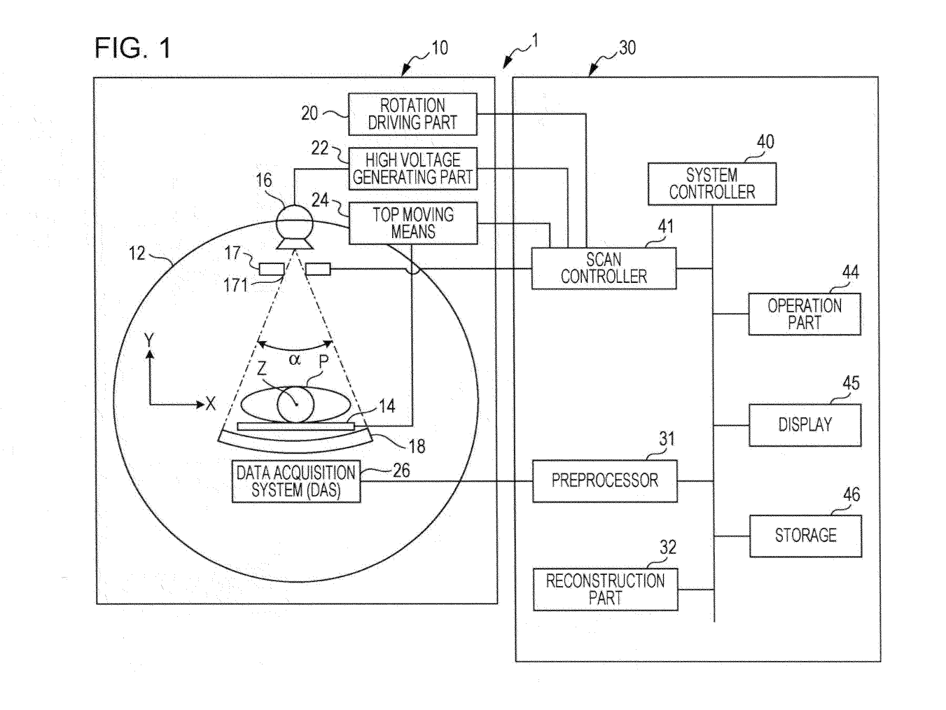

Hereinafter, an X-ray CT system according to the first embodiment will be described. FIG. 1 is a block diagram illustrating the function of an X-ray CT system according to the present embodiment.

Hereinafter, various embodiments of the X-ray CT system will be described with reference to the drawings.

### First Embodiment

The configuration of the X-ray CT system according to the first embodiment will be described with reference to FIG. 1. FIG. 1 is a block diagram illustrating the configuration of the X-ray CT system.

As illustrated in FIG. 1, the X-ray CT system 1 has a gantry 10 and a console 30.

### Gantry

The gantry 10 comprises a rotating frame 12, an X-ray tube 16, a collimator 17, an X-ray detector 18, a rotation driving part 20, a high voltage generating part 22, and a Data Acquisition System (DAS) 26.

The main body of the gantry 10 supports an annular or disk-shaped rotating frame 12 so as to be capable of rotating. On the inner peripheral side of the rotating frame 12, a scan region is formed, into which a subject P mounted on the top 14 is to be inserted.

On a bed (not illustrated), a top moving means 24 is provided so as to be capable of longitudinally moving the top 14 (in the rostrocaudal direction of the subject P). In addition, on the bed, an elevating means (illustration thereof is omitted) is disposed for vertically sliding the top 14 (upper and lower direction).

Here, an XYZ orthogonal coordinate system is defined. The Z axis is defined as the rotational axis of the rotating frame 12. The top 14 is arranged such that the longitudinal direction thereof is in parallel with the Z axial direction. Accordingly, the body axis of the subject P is in parallel with the Z axis. The X axis is defined as the horizontal axis, while the Y axis is defined as the vertical axis.

Further, there are various types of X-ray CT systems 1 such as a ROTATE/ROTATE type in which the X-ray tube 16 and the X-ray detector 18, etc. rotate together around the subject, and a STATIONARY/ROTATE type in which many detecting elements are arranged in a ring shape and the X-ray tube 16 only rotates around the subject. However, any type of X-ray CT system 1 can be applied to the present embodiment. Here, a description will be provided assuming that the ROTATE/ROTATE type of X-ray CT system 1 is used.

The X-ray tube 16, the collimator 17, and the X-ray detector 18 are disposed on the rotating frame 12.

Upon receiving driving signals from the rotation driving part 20, the rotating frame 12 continuously rotates the X-ray tube 16 and the X-ray detector 18.

### X-Ray Tube

The X-ray tube 16 generates X-rays applied with a high voltage and supplied with a filament current from the high voltage generating part 22.

The X-ray tube 16 and the X-ray detector 18 are arranged so as to oppose each other through the subject P mounted on the top 14.

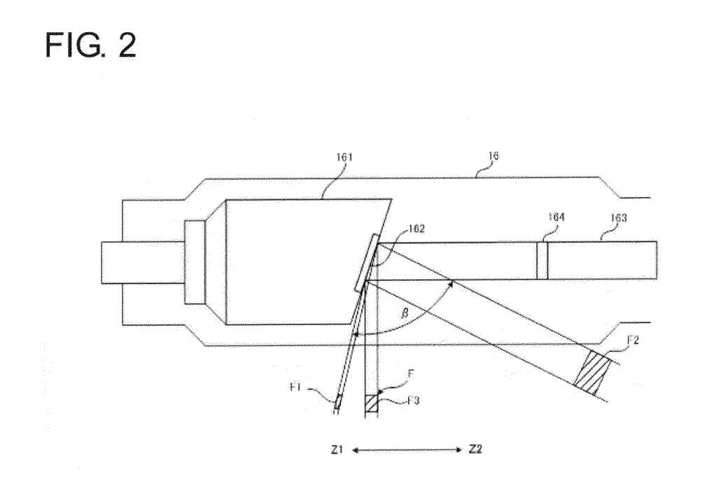

FIG. 2 is a conceptual illustration of the X-ray tube 16. As illustrated in FIG. 2, the X-ray tube 16 has an anode 161 with an emission surface (target) 162 for emitting X-rays and a cathode 163 with a filament 164. X-rays having a cone angle (represented by “β” in FIG. 2) are irradiated onto the subject so as to spread from the emission surface 162 in the rostrocaudal direction of the subject. The focal spot size (size of the effective focal spot F) indicated by hatching in FIG. 2 is different for the case in which the emission surface is observed from near the anode 161 (F1) and for the case in which the emission surface is observed from near the cathode 163 (F2). Furthermore, although the spreading of the cone angle is in the rostrocaudal direction in the following descriptions, it is not limited to the rostrocaudal direction.

As illustrated in FIG. 2, since the emission surface is a plane having a specific angle in the direction of the cathode 163, the emission surface is configured such that the focal spot size observed from the near anode 161 is made smaller, and the focal spot size is made increasingly larger in accordance with changes in the observing direction from the anode 161 to the cathode 163. FIG. 2 illustrates a focal point with a small focal spot size, a focal point with a large focal spot size, and a focal point with a moderate focal spot size as “F1,” “F2,” and “F3,” respectively.

The side near the anode 161 where the focal spot size is small is sometimes referred to as one end side of a cone angle 13 or a Z1 side (shown in FIG. 2). In addition, the side near the cathode 163 where the focal spot size is larger is sometimes referred to as the other end side of the cone angle β or a Z2 side (shown in FIG. 2).

### Collimator

As illustrated in FIG. 1, the collimator 17 has an aperture 171 through which the X-rays pass and is configured so as to limit the irradiation range of the X-rays for the subject by adjusting the range and position of the aperture 171. To limit the irradiation range means to narrow the irradiation range of the X-rays that spread at the cone angle β down to the irradiation range of the X-rays in a specific direction.

### X-Ray Detector

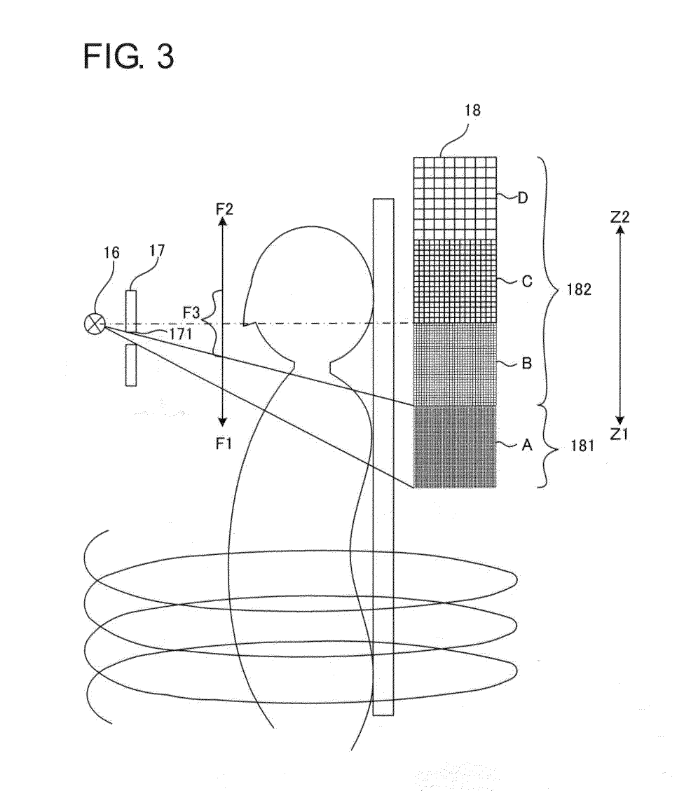

Next, the X-ray detector 18 will be described with reference to FIGS. 3 to 8. FIG. 3 illustrates the X-ray detector 18 of the hybrid-type having a small detection range 181 at one end in the rostrocaudal direction. Here, the small detection range 181 means the range over which the specific number of rows of the X-ray detecting elements of small detector size are arranged. In addition, a large detection range 182 means the range over which the specific number of rows of the X-ray detecting elements of large detector size are arranged. In the following description, the detector size is relatively determined.

As illustrated in FIG. 3, the small detection range 181 is arranged at one end (Z1 side) of the X-ray detector 18, while the large detection range 182 is arranged on the center part and at the other end (Z2 side) of the X-ray detector 18.

As the small detection range 181, an X-ray detecting element (an X-ray detecting element of small detector size) is used, with an element having a detector size that is the size in the rostrocaudal direction, for example, 0.5 mm. The small detection range 181 is configured such that X-ray detecting element groups of the specific number of rows with a plurality of X-ray detecting elements arranged in the X axial direction is arranged in the Z axial (rostrocaudal) direction. The small detection range 181 is represented by “A” in FIG. 3. Hereinafter, “A” is sometimes referred to as the detection region.

The large detection range 182 is configured such that the size of the X-ray detecting element becomes gradually larger from near the small detection range 181 to the direction away therefrom. The large detection ranges 182 are represented by “B,” “C,” “D” in FIG. 3. Hereinafter, “B,” “C,” and “D” are sometimes referred to as detection regions.

For detection regions B, C, and D, X-ray detecting elements having detector sizes larger than the detection size of the X-ray detecting element (for example, 0.5 mm) used for the small detection range 181 may be used. Here, in order to simplify the explanation, the detector sizes of the X-ray detecting elements in detection regions B, C, and D are determined to be 1.0 mm, 2.0 mm, 4.0 mm, respectively.

These detection regions B, C, and D are configured such that the X-ray detecting element groups of many rows with a plurality of X-ray detecting elements arranged in the X axial direction are arranged in the Z axial (rostrocaudal) direction.

Upon helical CT scanning, the X-rays (cone-beam) are irradiated onto the subject P while moving the top 14 in the rostrocaudal direction.

Next, the relationship between the focal spot size and the detector size of the X-ray detecting element will be described.

At first, the case in which, for example, the focal point F 1 of small focal spot size and the X-ray detecting element of small detector size in detection region A correspond to each other by limiting the irradiation range of the X-rays with the collimator 17 will be described.

The X-rays from a focal point F1 turn into thin beams to transmit through a part of the subject, and these beams are detected by the X-ray detecting element of small detector size. At this time, X-rays from the focal point other than the focal point F1 do not transmit through a part of the subject and they are detected by X-ray detecting elements other than the X-ray detecting element of small detector size. Since the X-ray detecting element does not detect anything other than said part of the subject, it is possible to image said part of the subject with high resolution.

In contrast, the case in which, for example, the focal point F2 of large focal spot size and a plurality of X-ray detecting elements of small detector size in detection region A correspond to each other by limiting the irradiation range of the X-rays with the collimator 17 will be described.

The X-rays from a focal point F2 turn into broad beams to transmit through a part of the subject, and these beams are detected by the X-ray detecting element of small detector size. In this case, the broad beams transmit through another part of the subject and are detected by this X-ray detecting element. Since the X-ray detecting element detects places other than said part of the subject, it is not possible to image said part of the subject with high resolution. In other words, low resolution imaging is carried out.

Accordingly, in order to carry out high resolution imaging, it is necessary to cause the focal point F1 of small focal spot size to correspond to the X-ray detecting element of small detector size in detection region A by limiting the aperture 171 of the collimator 17.

In addition, X-ray imaging in which the focal point F2 of large focal spot size corresponds to the X-ray detecting element of small detector size becomes low resolution imaging; consequently, the X-ray detecting element of small detector size cannot be sufficiently utilized. However, in the X-ray imaging in which the focal point F2 of large focal spot size corresponds to the X-ray detecting elements of the large detection size arranged over a wide range in the rostrocaudal direction, even with low resolution, imaging over a wide range can be carried out. In other words, in order to carry out low resolution imaging over a wide range, it is necessary to cause the focal point F2 of large focal spot size to correspond to the X-ray detecting element of the large detection size arranged over a wide range in the rostrocaudal direction.

The top moving means 24 moves the top 14 at a specific speed in accordance with the control by a scan controller 41 within the console 30.

The projection time interval of the X-rays to the subject is, for example, ten times per second. The high voltage generating part 22 applies a high voltage and supplies a filament current to the X-ray tube 16 in accordance with the control by a scan controller 41 within the console 30.

The X-ray detector 18 detects the X-rays generated from the X-ray tube 16 and transmitted through the imaging region, then generates signals depending on the intensity of the detected X-rays. The Data Acquisition System (DAS) 26 is connected to the X-ray detector 18.

The Data Acquisition System 26 acquires current signals from the X-ray detector 18 in accordance with the control by the scan controller 41. The Data Acquisition System 26 amplifies the acquired current signals and generates projection data made up of digital signals by converting the amplified current signals into digital signals. The projection data is provided to the console 30 via wireless data transmission systems (illustration is omitted) every time data is generated. Due to repletion of CT scanning, projection data in time sequence is generated and supplied to the console 30.

### Console

As illustrated in FIG. 1, the console 30 has a preprocessor 31, a reconstruction part 32, a system controller 40, a scan controller 41, an operation part 44, a display 45, and storage 46. Further, the system controller 40 and the scan controller 41 are sometimes referred to as a controller.

### Preprocessor

The preprocessor 31 subjects the projection data supplied from the Data Acquisition System 26 in real-time to preprocessing such as logarithmic conversion, sensitivity correction, etc. Due to preprocessing, projection data used for image reconstruction is generated.

### Reconstruction Part

The reconstruction part 32 generates CT image data related to the subject P in real time based on the preprocessed projection data. In other words, the reconstruction part 32 reconstructs CT image data (CT attenuation values) in a time sequence based on the projection data in the time sequence.

An image reconstruction method employed by the X-ray CT system 1 includes full-scan reconstruction and half-scan reconstruction. In full-scan reconstruction, in order to reconstruct data of the CT images for 1 slice, projection data of one cycle around the subject, namely, projection data for about 2π[rad] is needed. In addition, in half-scan reconstruction, in order to reconstruct image data for 1 slice, the projection data for π+α [rad] (α: a fan angle) is needed. According to the present embodiment, both full-scan reconstruction and half-scan reconstruction can be applied.

### System Controller

The system controller 40 functions as the center of the X-ray CT system 1. Specifically, the system controller 40 reads control programs stored in the storage 46, expands the programs in memory, and controls respective parts in accordance with the expanded control programs. Thereby, the system controller 40 can carry out CT scanning.

The scan mode includes first to third modes. The first mode serves to carry out high resolution imaging by limiting the collimator 17 so as to cause the focal point F1 of small focal spot size to correspond to the small detection range 181. The second mode serves to carry out moderate resolution imaging or low resolution imagine by limiting the collimator 17 so as to cause the focal point F2 of large focal spot size or the focal point F3 of moderate focal spot size to correspond to the large detection range 182. The third mode serves to carry out imaging at a desired resolution by releasing the control of the collimator so as to use all ranges of the X-ray detector 18.

Respective modes from the first mode to the third mode correspond to the range and position of the aperture 171 of the collimator 17, and these modes are stored in an internal memory of the system controller 40 or in the storage 46 as a database. The system controller 40 receives an indication of the first to third modes and outputs the range and position of the aperture 171 of the corresponding collimator 17 to the scan controller 41.

### Scan Controller

In order to carry out CT scanning, the scan controller 41 controls the gantry 10 (the collimator 17, the rotation driving part 20, the high voltage generating part 22, the top moving means 24, and the Data Acquisition System 26).

The scan controller 41 receives the range and position of the aperture 171 output from the system controller 40 and controls the collimator 17.

### First Mode

Next, with reference to FIG. 3, as a scan mode, the first mode of carrying out CT scanning while causing the small detection range 181 to correspond to the focal point F1 of small focal spot size will be described.

FIG. 3 illustrates the X-ray detector 18 in the case of carrying out CT scanning using the small detection range 181. In FIG. 3, the small detection range 181 and the focal point F1 of small focal spot size (refer to FIG. 2) corresponding to each other across the subject are illustrated.

When the system controller 40 receives instructions from the first mode, the scan controller 41 controls the aperture 171 of the collimator 17, selects the X-rays from the focal point F1 in FIG. 2, and irradiates the selected X-rays onto the small detection range 181. Thereby, the small detection range (X-ray detecting element of the small detection size) 181 arranged near the Z1 corresponds to the focal point F1 of small focal spot size near the Z1. Thereby, it is possible to sufficiently utilize the X-ray detecting element of small detector size, and further, it is possible to efficiently acquire high resolution upon imaging.

In addition, the scan controller 41 outputs a specific speed to the top moving means 24. The top moving means 24 moves the top 14 at said specific speed. During movement of the top 14, the X-rays are irradiated onto the subject from the focal point F1 of small focal spot size, and the transmission X-rays are detected by the small detection range 181.

The Data Acquisition System 26 acquires the projection data based on the X-rays detected by the small detection range 181. Further, the projection data acquired based on the X-rays detected by the small detection range 181 is sometimes referred to as first projection data. The reconstruction part 32 reconstructs images of a high resolution based on the first projection data.

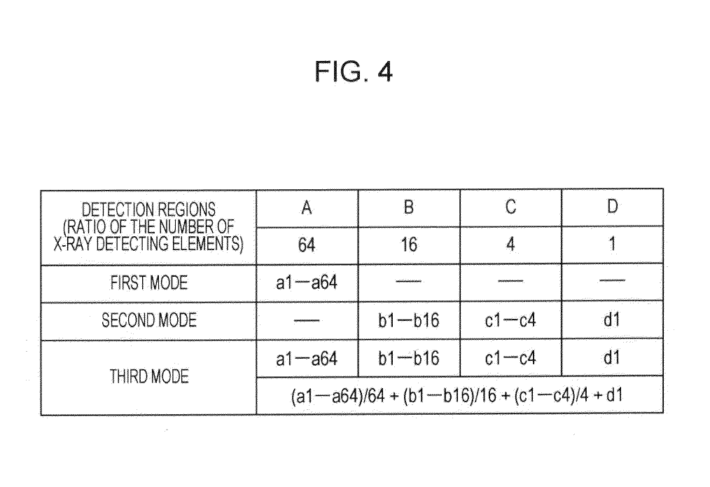

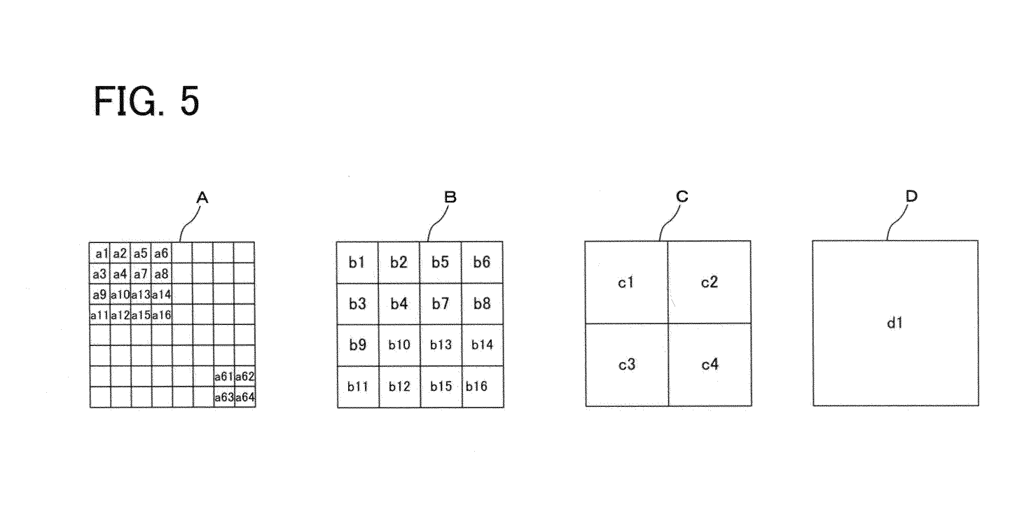

Next, with reference to FIG. 4 and FIG. 5, projection data obtained when imaging is carried out in the first mode will be described. FIG. 4 illustrates the number of X-ray detecting elements to be used for detecting a part of the subject (having a specific size) in respective detection regions A, B, C, and D, as well as the projection data acquired based on the X-rays detected by the X-ray detecting elements, and FIG. 5 illustrates the X-ray detecting element and the projection data as corresponding to each other.

As illustrated in FIG. 4, as an example of the ratio of the number of X-ray detecting elements used for detecting a part of the subject in detection regions A, B, C, and D, 64:16:4:1 is considered. These numeric values correspond to 0.5 mm, 1.0 mm, 2.0 mm, and 4.0 mm, which are the detector sizes of detection regions A, B, C, and D as described above.

The X-ray detecting elements should be represented by the real number of units corresponding to the ratio; however, in order to simplify the explanation, FIG. 5 indicates the ratio by number of pieces, in A, 64 pieces, in B, 16 pieces, in C, 4 pieces s, and in D, 1 piece.

As illustrated in FIG. 5, in the first mode in which detection region A is used, the projection data acquired based on the X-rays detected by 64 pieces of the X-ray detecting elements is defined as “a1,” “a2,” . . . , “a64.” Since a part of the subject is imaged using 64 pieces of the X-ray detecting elements, high resolution imaging is made possible. The reconstruction part 32 can reconstruct the images of a part in the subject at a high resolution based on these 64 pieces of projection data. Based on the images at a high resolution, it is possible to carry out diagnostic imaging with minute construction, for example, on a cancer.

In the above, as a scan mode, an example of the first mode to carry out CT scanning while causing the small detection range 181 and the focal point F1 of small focal spot size to correspond to each other is indicated.

### Second Mode

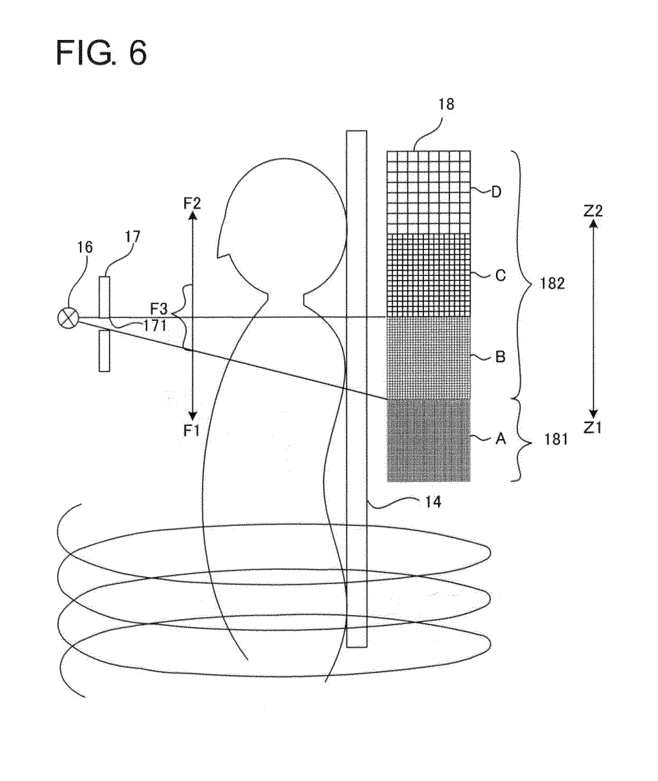

Next, with reference to FIG. 6, as a scan mode, the second mode of carrying out CT scanning while causing the large detection range 182 to correspond to the focal point F2 of large focal spot size or the focal point F3 of moderate focal spot size will be described.

FIG. 6 illustrates the X-ray detector 18 when it carries out CT scanning using a detection region B. FIG. 6 illustrates detection region B and a focal point F3 of moderate focal spot size corresponding to each other across the subject.

When the system controller 40 receives instructions from the second mode, the scan controller 41 moves the position of the aperture 171 from the initial position (a center line: a dashed line shown in FIG. 6) in the Z2 direction for a specific amount, and controls the collimator 17 so as to make the range of the aperture 171 smaller from the initial value. Thereby, detection region B arranged on the Z2 side and the focal point F3 arranged on the Z2 side correspond to each other.

In addition, the scan controller 41 outputs a specific speed to the top moving means 24. The top moving means 24 moves the top 14 at said specific speed. By irradiating the X-rays onto the moved subject from the focal point F3 and detecting the X-rays by detection region B, it is possible to carry out moderate resolution imaging.

In other words, the Data Acquisition System 26 acquires projection data based on the X-rays detected by detection region B. Further, the projection data acquired based on the X-rays detected by detection region B is sometimes referred to as second projection data. The reconstruction part 32 reconstructs images in a moderate resolution based on the second projection data.

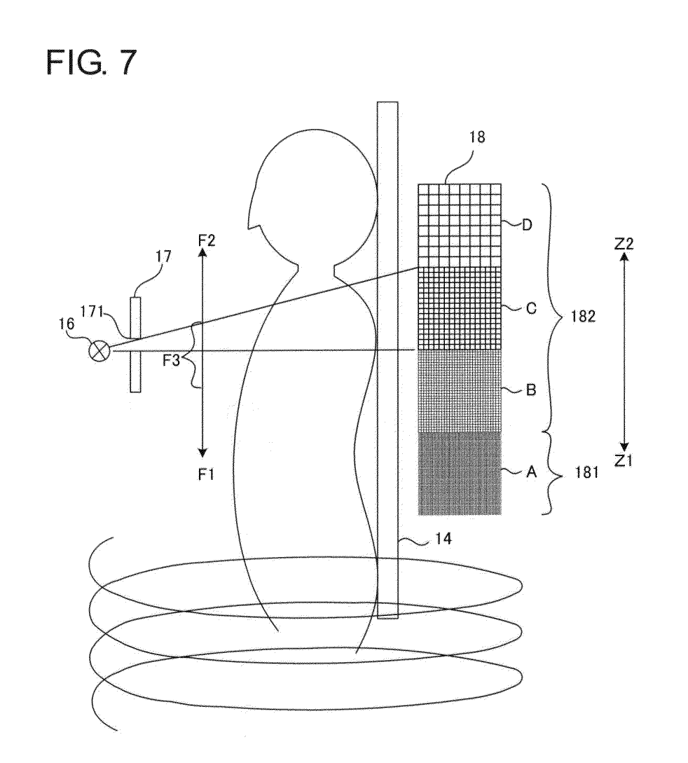

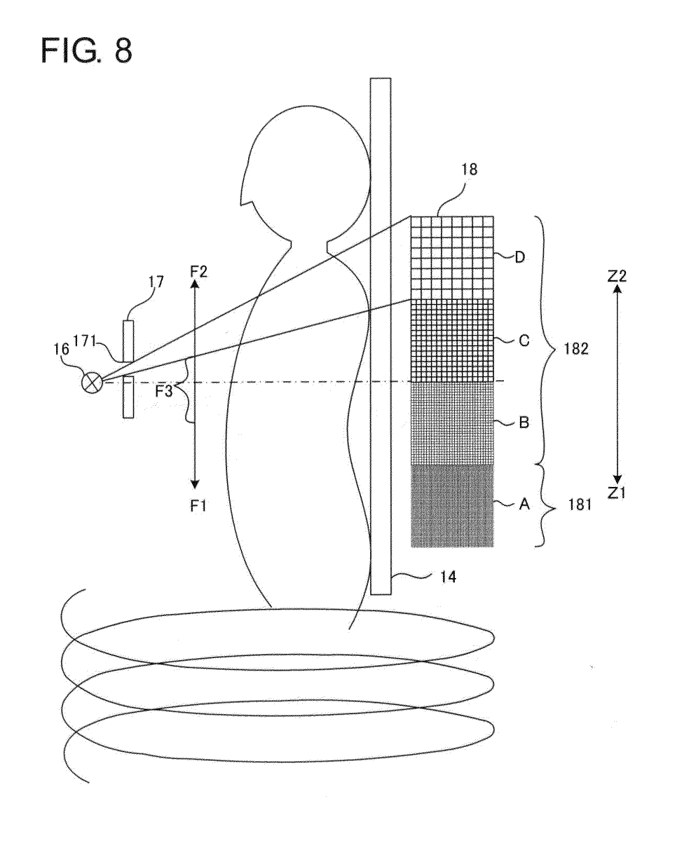

Next, the case of carrying out CT scanning using detection region C or D will be described with reference to FIG. 7 and FIG. 8. FIG. 7 illustrates the X-ray detector when it carries out CT scanning using detection region C, while FIG. 8 illustrates the X-ray detector when it carries out CT scanning using detection region D.

FIG. 7 illustrates detection region C and the focal point F3 of moderate focal spot size corresponding to each other across the subject. In addition, FIG. 8 illustrates detection region D and the focal point F2 of large focal spot size corresponding to each other across the subject.

The case of carrying out CT scanning using detection region C is similar to the case of carrying out CT scanning using detection region B. In other words, by irradiating the X-rays from the focal point F3 and detecting these X-rays by detection region C, it is possible to carry out moderate resolution imaging. The Data Acquisition System 26 acquires projection data based on the X-rays detected by detection region C. Further, the projection data acquired based on the X-rays detected by detection region C is sometimes referred to as second projection data. The reconstruction part 32 reconstructs images in a moderate resolution based on this second projection data. Here, the resolution in which CT scanning is carried out using detection region C is lower than the resolution in which CT scanning is carried out using detection region B.

In the case of carrying out CT scanning using detection region D, imaging is carried out by relating detection region D to the focal point F2 of large focal spot size. Thereby, it is possible to carry out low resolution imaging. The Data Acquisition System 26 acquires projection data based on the X-rays detected by detection region D. Further, the projection data acquired based on the X-rays detected by detection region D is sometimes referred to as second projection data. The reconstruction part 32 reconstructs images in a low resolution based on the second projection data.

In the second mode, by selecting detection regions B to D, although the resolution is lower than that of the first mode, it is possible to image the subject over a wide range. Therefore, in the second mode, low exposure is valued over the resolution. Further, imaging at a desired level of resolution is made possible.

In the above, CT scanning in the second mode using any region of detection regions B, C, and D is described. Without limiting this, it is obvious that a combination of two or more detection regions such as detection regions B and C, detection regions C and D, or detection regions B, C, and D may be used in the case of carrying out CT scanning in the second mode.

Next, the projection data obtained via imaging in the second mode will be described with reference to FIG. 4.

In the second mode in which detection region B is used, the projection data acquired based on the X-rays detected by 16 pieces of the X-ray detecting elements in detection region B is defined as “b1,” “b2,” and “a16.” Since a part of the subject is imaged using 16 pieces of the X-ray detecting elements, moderate resolution imaging is made possible. The reconstruction part 32 can reconstruct the images of a part in the subject in a moderate resolution based on these 16 pieces of projection data.

Further, in the second mode in which detection region C is used, the projection data acquired based on the X-rays detected by 4 pieces of the X-ray detecting elements in detection region C is defined as “c1,” “c2,” . . . , “c4.” Since a part of the subject is imaged using 4 pieces of the X-ray detecting elements, moderate resolution imaging is made possible. The reconstruction part 32 can reconstruct the images of a part in the subject in a moderate resolution based on these four projection data.

As described above, in the second mode, by combining two or more detection regions, it is possible to image the subject over a wide range at once. In other words, since the pitch of helical path can be widened, it is possible to reduce the time required to irradiate the X-rays and to carry out low exposure imaging.

Further, in the second mode in which detection region D is used, the projection data acquired based on the X-rays detected by 1 piece of the X-ray detecting element is defined as “d1.” Since a part of the subject is imaged using 1 piece of the X-ray detecting element, low resolution imaging is made possible. The reconstruction part 32 can reconstruct the images of a part in the subject in a low resolution based on one projection data.

In the above, it is described that a combination of two or more detection regions such as detection regions B and C, detection regions C and D, or detection regions B, C, and D may be used.

With reference to FIG. 4, the projection data obtained via imaging in the second mode in which a combination of two or more detection regions is used will be described.

As an example, the projection data with detection regions B and C combined will be described with reference to FIG. 4 and FIG. 5.

As described above, with respect to the projection data upon detecting a part of the subject using the X-ray detecting elements of detection regions B and C, in detection region B, the projection data is defined as “b1,” “b2,” . . . , “a16,” and in detection region C, the projection data is defined as “c1,” “c2,” . . . , “c4.”

As illustrated in FIG. 5, “b1” to “b4” in detection region B correspond to “c1” in detection region C, “b5” to “b8” in detection region B correspond to “c2” in detection region C, “b9” to “b12” in detection region B correspond to “c3” in detection region C, and “b13” to “b16” in detection region B correspond to “c4” in detection region C, respectively.

The composition of this projection data turns into the projection data when detection regions B and C are combined. For example, the composed projection data is derived from the average value of the projection data and is represented by the following expressions.

c1a=((b1+b2+b3+b4)/4+c1)/2 (1)

c2a=((b5+b6+b7+b8)/4+c2)/2 (2)

c3a=((b9+b10+b11+b12)/4+c3)/2 (3)

c4a=((b13+b14+b15+b16)/4+c4)/2 (4)

Here, “c1a,” “c2a,” “c3a,” and “c4a” indicate respective values of the composed projection data. Further, the projection data “b1” to “b16,” and “c1” to “c4” may be weighted.

In the same way, it is also possible to derive the projection data when detection regions C and D and detection regions B, C, and D are combined.

### Operation Part

The operation part 44 receives various instructions and information from the operator. For example, in the operation part 44, a scan mode is input by the user via an input device. As the input device, a keyboard, a mouse, a switch, etc. are available.

### Display

The display 45 displays the CT images on a display device. As the display device, for example, a CRT display, a liquid crystal display, an organic EL display, a plasma display, etc. are available.

### Storage

The storage 46 stores projection data and the data of CT images. In addition, the storage 46 stores control programs in advance.

### Operation

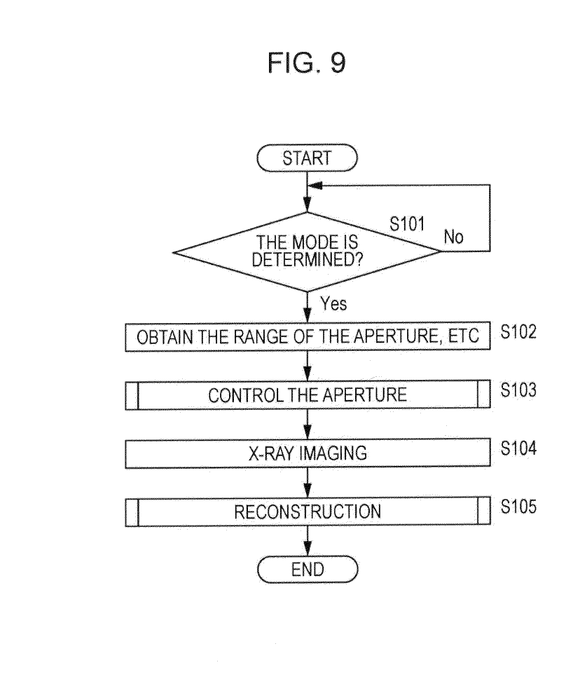

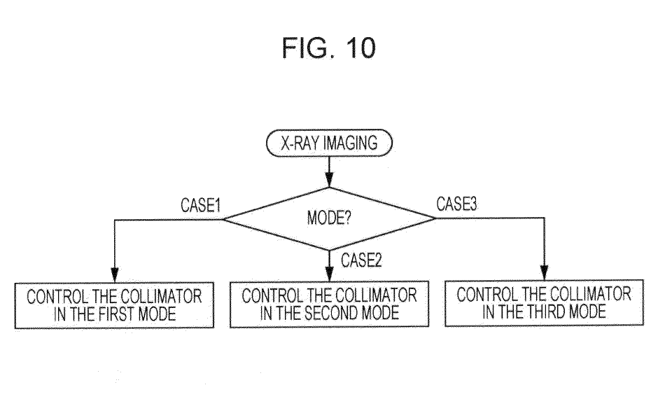

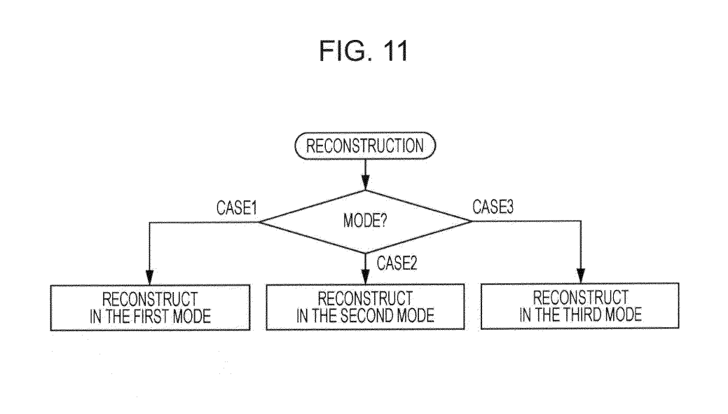

Next, CT scanning carried out by the X-ray CT system 1 will be described with reference to FIG. 9, FIG. 10, and FIG. 11. FIG. 9 is a flow chart illustrating the operation of the X-ray CT system 1, FIG. 10 is a flow chart illustrating the control of the collimator 17, and FIG. 11 is a flow chart illustrating a reconstruction.

### S101

### Determine the Mode

Due to the operation of the operation part 44, the first to third modes are input in the system controller 40. Further, a third mode in which limitation of the irradiation range by the X-rays is released and CT scanning is carried out using all of detection regions A to D will be described later.

As illustrated in FIG. 9, the system controller 40 determines whether or not a mode is input. Here, when the second mode is input via the operation of the operation part 44, further, via the operation of the operation part 44, any one or any two or more of detection regions B to D is/are input.

### S102

### Obtain the Range of the Aperture, Etc.

The system controller 40 obtains the range and position of the aperture 171 of the collimator 17 corresponding to the input mode, and the obtained range of the aperture 171, etc. is output to the scan controller 41.

### S103

### Control the Aperture

The scan controller 41 controls the collimator 17 based on the range and position of the aperture 171 of the collimator 17 corresponding to the input mode. By adjusting the range and the position of the aperture 171, it becomes possible to relate any of detection regions A, B, C, and D to the focal points F1, F2, and F3.

As illustrated in FIG. 10, in control of the collimator, when the first mode is input (CASE1 shown in FIG. 10), in the first mode, the collimator is controlled. In other words, the scan controller 41 controls the aperture 171 of the collimator 17 to relate detection region A to the focal point F1.

Further, when the second mode is input and the detection region is selected (CASE2 shown in FIG. 10), in the second mode, the collimator is controlled. In other words, the scan controller 41 controls the aperture 171 of the collimator 17 to relate the detection region to the focal point F2.

### S104

### X-Ray Imaging

When the first mode is input, the small detection range 181 detects the X-rays emitted from the focal point F1 of small focal spot size and transmitted through the subject. Thereby, upon imaging, high resolution can be obtained.

When the second mode is input and the detection region is selected, the selected detection region detects the X-rays emitted from the focal point F3 of moderate focal spot size or the focal point F2 of large focal spot size and transmitted through the subject. Thereby, upon imaging, moderate or low resolution can be obtained.

### S105

### Reconstruction

As illustrated in FIG. 11, when the first mode is input (CASE1 shown in FIG. 11), the DAS 26 acquires the projection data from the X-rays detected by the small detection range 181. The reconstruction part 32 reconstructs images based on the projection data. Thereby, images in a high resolution can be obtained.

When the second mode is input and the detection region is selected (CASE2 shown in FIG. 11), the DAS 26 acquires the projection data from the X-rays detected by the selected detection region. The reconstruction part 32 reconstructs images based on the projection data. Thereby, images in a moderate or a low resolution can be obtained.

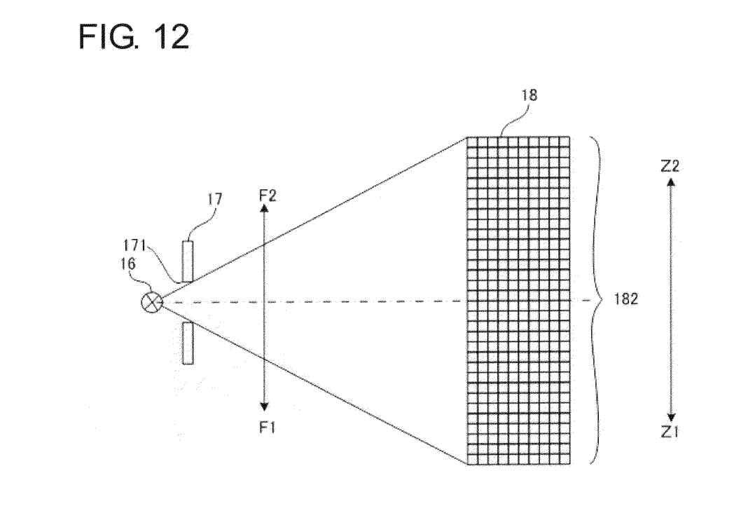

Here, the X-ray detector 18 according to the present embodiment illustrated in FIGS. 3 to 8 will be described by citing a comparative example thereof. FIG. 12 illustrates an X-ray detector 18 of an equal type according to the comparative example. As illustrated in FIG. 12, in the X-ray detector 18 of equal type, X-ray detecting elements of large detector size measuring 1.0 mm, are evenly arranged in the X-Z direction. In other words, the X-ray detector 18 is entirely configured by the large detection range 182.

In the X-ray detector 18 illustrated in FIG. 12, since the X-ray detector 18 is entirely configured by the large detection range 182, even if the range and the position of the aperture 171 are adjusted, the large detection range 182 corresponds to the focal point F1 of small focal spot size; however, even by relating the large detection range 182 to the focal point F1 of small focal spot size, upon imaging, high resolution cannot be obtained.

On the other hand, it is not efficient to use a small detector size for all of the X-ray detecting elements in the X-ray detector 18 illustrated in FIG. 12.

In contrast, in the X-ray detector 18 illustrated in FIG. 3, by disposing of the small detection range 181 at one end side of the X-ray detector 18, and relating this small detection range 181 to the focal point F1 of small focal spot size, upon imaging, high resolution can be obtained. In addition, not only high resolution imaging, but also imaging at a desired level of resolution is made possible by corresponding any one of detection regions B to D to the focal point F3 of moderate focal spot size or the focal point F2 of large focal spot size. Further, by combining two or more detection ranges of detection regions B to D, it is possible to image the subject over a wide range.

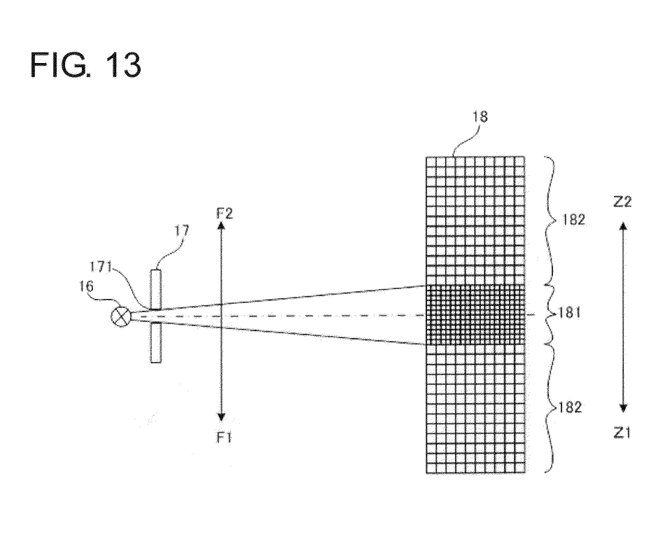

Further, the X-ray detector 18 according to the present embodiment will be described by citing a comparative example thereof. FIG. 13 illustrates an X-ray detector 18 of a hybrid-type according to the comparative example. As illustrated in FIG. 13, the small detection range 181 is arranged in the center part in the rostrocaudal direction of the X-ray detector 18, while the large detection ranges 182 are arranged anterior or posterior to the small detection range 181.

In the X-ray detector 18 of the comparative example in which the small detection range 181 is arranged on the center part in the rostrocaudal direction (Z direction) of the X-ray detector 18, the focal point F3 of moderate focal spot size corresponds to the small detection range 181. The focal point F1 of small focal spot size does not always correspond to the small detection range 181. As a result, the X-ray detecting element of small detector size cannot be sufficiently utilized.

In contrast, in the X-ray detector 18 illustrated in FIG. 3, the small detection range 181 is disposed on one end side of the X-ray detector 18, and this small detection range 181 is related to the focal point F1 of small focal spot size. Therefore, the X-ray detecting element of small detector size can be sufficiently utilized.

### Second Embodiment

In said first embodiment, as a scan mode, the first mode of carrying out CT scanning by relating the small detection range 181 to the focal point F1 of small focal spot size, and the second mode of carrying out CT scanning by relating the large detection range 182 to the focal point F2 of large focal spot size or the focal point F3 of moderate focal spot size are described. According to the first mode, high resolution imaging is made possible. In addition, according to the second mode, imaging at a desired level of resolution is made possible along with imaging of the subject over a wide range.

Besides the first mode and the second mode, the scan mode includes a third mode to carry out CT scanning using all ranges of the X-ray detector 18. According to the third mode, it is possible to simultaneously obtain both of the projection data imaged at high resolution and the projection data imaged at low resolution, and using the simultaneously-obtained projection data, images are reconstructed, and using these images, diagnostic imaging of a lesion site such as a cancer is carried out. When the user desires to obtain a high resolution at the location of a lesion site, it is possible to reconstruct images in the high resolution using the projection data imaged at high resolution.

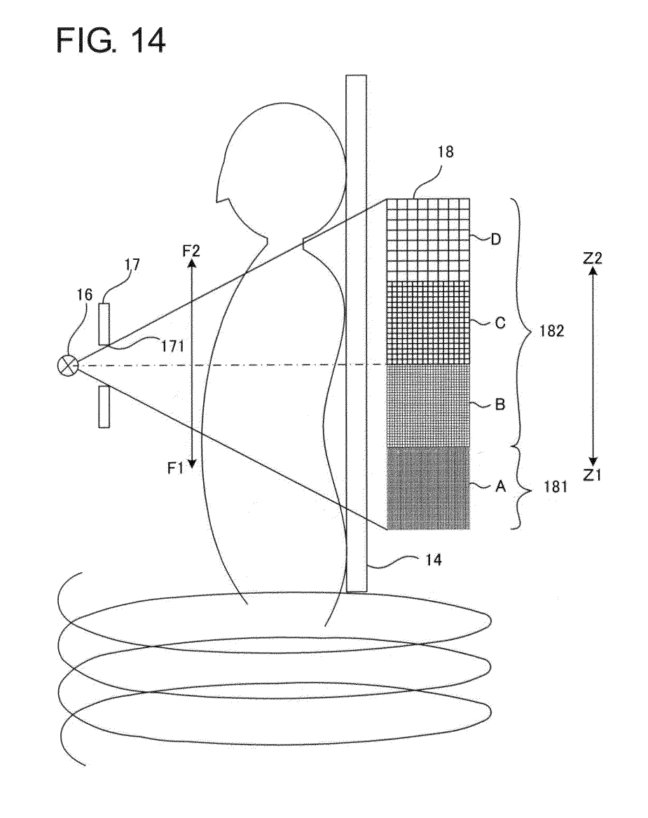

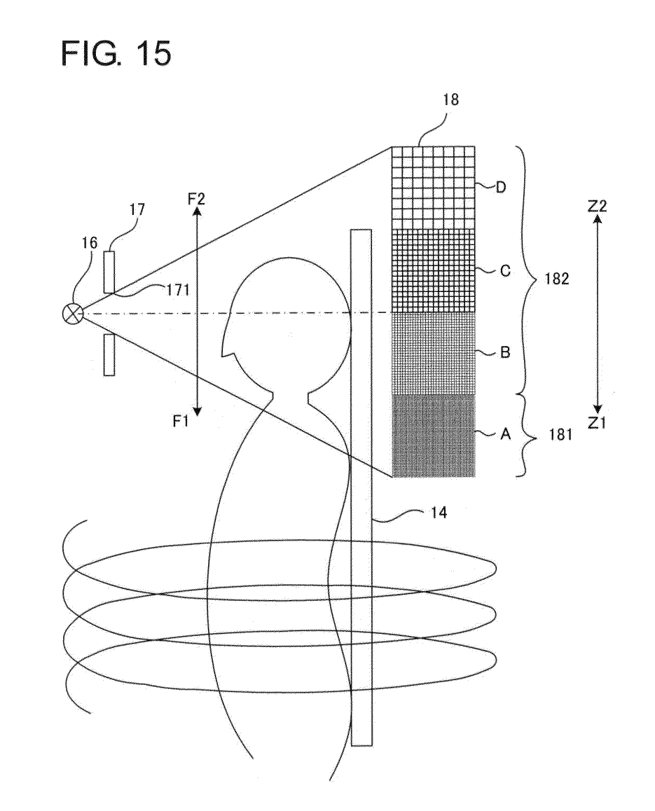

Next, the X-ray CT system 1 according to the second embodiment will be described with reference to FIG. 14 and FIG. 15. Further, in the second embodiment, configurations different from the first embodiment will mainly be described, with explanations of the same configurations omitted. FIG. 15 illustrates the X-ray detector when CT scanning is ended.

FIG. 14 illustrates the X-ray detector when CT scanning of the head and a bust of the subject using all of detection regions A to D is initiated.

Upon receiving a third mode (the range and the position of the aperture 171) output from the system controller 40, the scan controller 41 controls the collimator 17. The scan controller 41 controls the aperture 171 of the collimator 17 to irradiate X-rays from the focal points F1, F2, and F3 to all of detection regions A to D. All detection regions A to D irradiated by the X-rays are illustrated in FIG. 14.

As illustrated in FIG. 14, the focal point F1 of the X-ray tube 16 corresponds with detection region A, the focal point F3 corresponds to detection region B, the focal point F3 corresponds to detection region C, and the focal point F2 corresponds to detection region D, respectively.

In helical CT scanning, the scan controller 41 moves the top 14 in the rostrocaudal direction (Z2 direction: the direction of the position of the top 14 illustrated in FIG. 15), and the X-rays (cone-beam) are irradiated onto the subject P. Thereby, the X-rays transmitted through the subject P are detected by respective detection regions A, B, C, and D.

The DAS 26 acquires projection data based on the X-rays detected by respective detection regions A, B, C, and D.

Next, the projection data obtained via imaging in the third mode will be described with reference to FIG. 4.

In FIG. 4, the projection data acquired based on the X-rays detected by 64 pieces of the X-ray detecting elements in detection region A is defined as “a1,” “a2,” . . . , “a64.” In addition, the projection data acquired based on the X-rays detected by 16 pieces of the X-ray detecting elements in detection region B is defined as “b1,” “b2,” . . . , “a16.” Further, the projection data acquired based on the X-rays detected by 4 pieces of the X-ray detecting elements in detection region C is defined as “c1,” “c2,” . . . , “c4.” Further, the projection data acquired based on the X-rays detected by 1 piece of the X-ray detecting elements in detection region D is defined as “d1.”

This projection data is composed. The composed projection data will be described with reference to FIG. 5.

### Correspondence of Detection Regions A, B

As illustrated in FIG. 5, “a1” to “a4” in detection region A correspond to “b1” in detection region B, “a5” to “a8” in detection region A correspond to “b2” in detection region B, “a9” to “a12” in detection region A correspond to “b3” in detection region B, and “a13” to “a16” in detection region A correspond to “b4” in detection region B, respectively. Hereinafter, in the same way, the projection data in detection region A corresponds to the projection data in detection region B. Finally, “a61” to “a64” in detection region A correspond to “b16” in detection region B.

### Correspondence of Detection Regions B, C

In the above description regarding the second mode in which a combination of detection regions B and C is used, it is explained that the projection data in detection region B corresponds to the projection data in detection region C.

### Correspondence of Detection Regions C, D

As illustrated in FIG. 5, “c1” to “c4” in detection region C correspond to “d1” in detection region D.

The composition of this projection data turns into projection data when detection region A, B, C, and D are combined. For example, the composed projection data is derived from the average value of the projection data and is represented by the following expression.

d1a=((a1 to a64)/64+(b1 to b16)/16+(c1 to c4)/4+d1)/4 (5)

Here, “d1a” indicates the value of the composed projection data. In addition, (a1 to a64) indicates (a1+a2+ . . . +a64), (b1 to b16) indicates (b1+b2+ . . . +b16), and (c1 to c4) indicates (c1+c2+ . . . +c4), respectively. Further, the projection data “a1” to “a64,” “b1” to “b16,” and “c1” to “c4” may be weighted. Here, each projection data before composition is sometimes referred to as third projection data, and the composed projection data is sometimes referred to as fourth projection data.

### Operation

Next, CT scanning carried out by the X-ray CT system 1 will be described with reference to FIG. 9, FIG. 10, and FIG. 11. Here, a description will be provided assuming that the third mode is input into the system controller 40 by the operation of the operation part 44.

The system controller 40 determines the input mode (S101), obtains the range and position of the aperture 171 of the collimator 17 corresponding to the input mode, and outputs the range, etc. of the aperture 171 to the scan controller 41 (S102).

The scan controller 41 controls the collimator 17 based on the range and position of the aperture 171 of the collimator 17 corresponding to the input mode (S103).

As illustrated in FIG. 10, in control of the collimator, when the third mode is input (CASE3 shown in FIG. 10) in the third mode, the collimator is controlled. In other words, the scan controller 41 controls the aperture 171 of the collimator 17 to relate all of detection regions A, B, C, D to all of the focal points F1, F2, F3.

X-ray imaging is carried out in the third mode (S104). At this time, detection region A detects the X-rays emitted from the focal point F1 of small focal spot size and transmitted through the subject. Detection region B detects the X-rays emitted from the focal point F3 of moderate focal spot size subject and transmitted through the subject. Detection region C detects the X-rays emitted from the focal point F3 of moderate focal spot size and transmitted through the subject. Detection region D detects the X-rays emitted from the focal point F2 of large focal spot size and transmitted through the subject.

As illustrated in FIG. 11, when the third mode is input (CASE3 shown in FIG. 11), the DAS 26 acquires the projection data from the X-rays detected by respective detection region A, B, C, and D. The reconstruction part 32 reconstructs images based on the projection data.

Upon reconstructing images, the reconstruction part 32 may use the third projection data before composition or the composed fourth projection data.

For example, the reconstruction part 32 may automatically reconstruct images using the composed fourth projection data, and further, receiving the scan mode input in the operation part 44 from the operation part 44, the reconstruction part 32 may reconstruct images using the third projection data before composition.

The reconstruction part 32 reconstructs images using the composed fourth projection data, and can carry out diagnostic imaging of a lesion site such as a cancer using these images. Further, the reconstruction part 32 reconstructs images using the third projection data before composition (for example, the projection data acquired based on the X-rays detected by detection region A), and can carry out diagnostic imaging of the position of the lesion site using these images in the high resolution.

Without limiting this, for example, the reconstruction of images using the third projection data before composition and reconstruction of images using the composed fourth projection data may be automatically carried out in each predetermined order.

### Third Embodiment

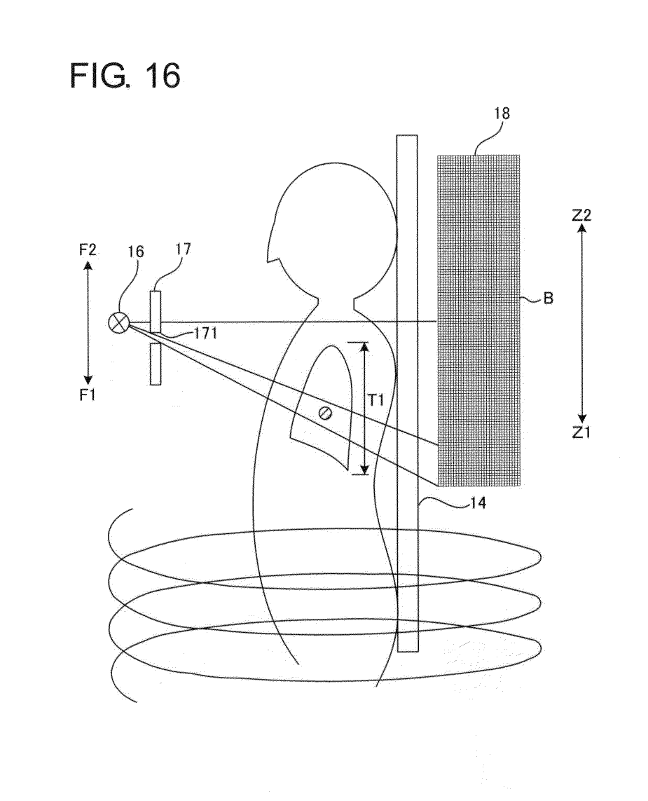

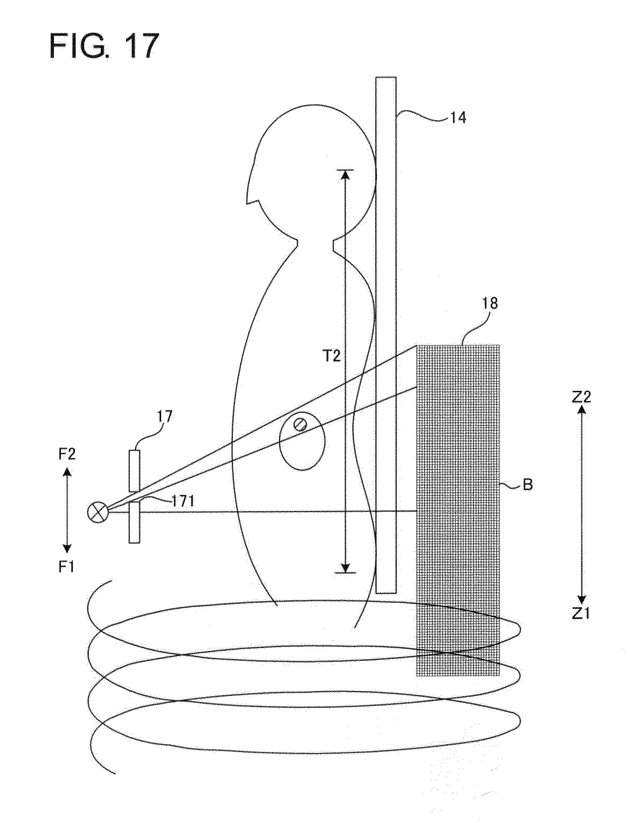

Next, the X-ray CT system 1 according to the third embodiment will be described with reference to FIG. 16 and FIG. 17. In said third embodiment, the configurations different from the above-described embodiments will be mainly described, with the same configurations provided with the same numbers. Explanation thereof is herein omitted.

In the X-ray CT system 1 according to the above-described embodiments, upon imaging the X-rays, in the helical CT scanning for moving the top 14 in the rostrocaudal direction while rotating the X-ray tube 16 and the X-ray detector 18 around the body axis, the desired projection data can be obtained by controlling the collimator 17 by use of the controller, by irradiating the X-rays on a specific detection region including the small detection range 181 and the large detection range 182 having different size X-ray detecting elements from the effective focal spots of different sizes. In contrast, in the X-ray CT system 1 according to the third embodiment, the X-ray imaging is not limited to helical scanning, the sizes of the X-ray detecting elements are even over the detection region, and the X-rays are irradiated from the effective focal spot onto the even detection region. Consequently, the desired projection data can be obtained.

The controller is configured to select the effective focal spot of any size from small to large by controlling the collimator 17.

FIG. 16 illustrates CT scanning in which X-rays are irradiated from the effective focal spot of small size. As illustrated in FIG. 16, the X-ray detector 18 has a detection region configured by the X-ray detecting elements of even size. This detection region is positioned at the end near the anode in all detection regions, and this is referred to as the detection region near F1. This detection region may be of any size if the sizes of the X-ray detecting elements are even. The size of this detection region may be equivalent to, for example, any size of detection regions A to D according to the above-described embodiments; however, here, this size is equivalent to the size of detection region B according to the above-described embodiments. Therefore, this detection region is illustrated in FIG. 16 with “B” (hereinafter, the same applies).

The controller controls the collimator 17 such that the X-rays are irradiated from the effective focal spot of small size positioned near the anode onto detection region B near F1. Since the X-rays are irradiated from the effective focal spot of small size onto detection region B near F1, it is possible to improve the resolution of the projection data obtained through CT scanning, and for example, it is possible to clarify the nebular shadow of the lungs (the nebular shadow is illustrated in FIG. 16 with hatching).

Further, the CT scan illustrated in FIG. 16 is not limited to the helical scanning of irradiating the X-rays while moving the top 14; however, this CT scan may be defined as helical scanning. For example, the entire range of the lungs (“T1” shown in FIG. 16) may be imaged.

FIG. 17 illustrates CT scanning in which X-rays are irradiated from an effective focal spot of large size. As illustrated in FIG. 17, here, detection region B is positioned at the end near the cathode in all detection regions, and this is referred to as the detection region near F2. Since the X-rays are irradiated from the effective focal spot of large size positioned near the cathode onto detection region B near F2, it is possible to reduce any noise from the projection data obtained through CT scanning and clarify the differences in concentration of images. For example, it is possible to clarify the CT shadow of a liver (the shadow in shown in FIG. 17 with hatching).

In the same way, assuming that the CT scan illustrated in FIG. 17 is helical scanning, for example, by imaging the range from the head to the crural area (“T2” shown in FIG. 17), it may be possible to diagnose displacement of a lesion, etc.

Although control of the collimator is not particularly limited, the controller may be configured to control the collimator in accordance with the condition when the X-rays are irradiated (referred to as CT scan planning).

In addition, the controller may be configured to be capable of switching the effective focal spot between one effective focal spot of any size from small to large size (for example, the effective focal spot illustrated in FIG. 16) and another effective focal spot of different size from the above size (for example, the effective focal spot illustrated in FIG. 17) by controlling the collimator 17.

For example, the controller may control the collimator 17, such that, during helical scanning, in the case of obtaining projection data with high resolution by switching the effective focal spot, imaging is carried out using the effective focal spot of small size, and in the case of obtaining the projection data with low noise by switching the effective focal spot, imaging is carried out using the effective focal spot of large size.

Although it is illustrated that the X-rays are irradiated onto detection region B near F1 from the effective focal spot of small size, and the X-rays are irradiated onto detection region B near F2 from the effective focal spot of large size, it is obvious that the present invention is not limited to this.

### Fourth Embodiment

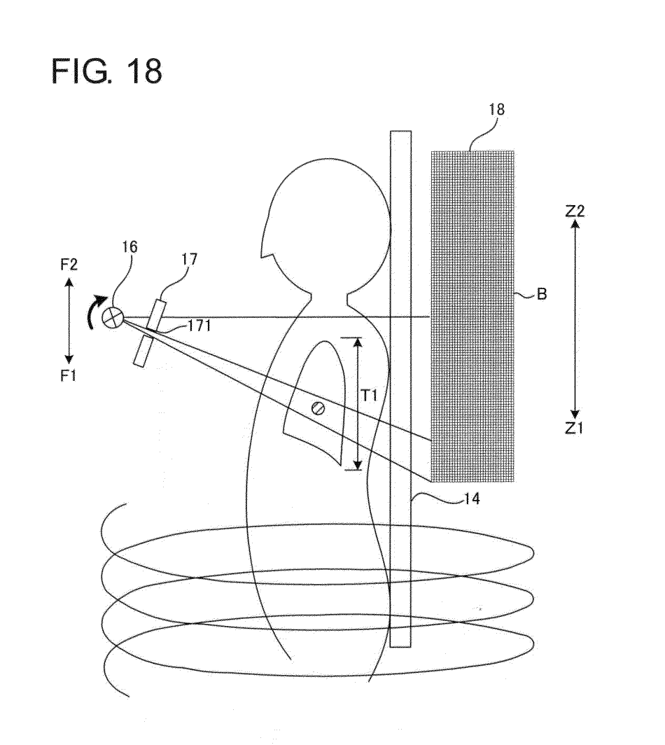

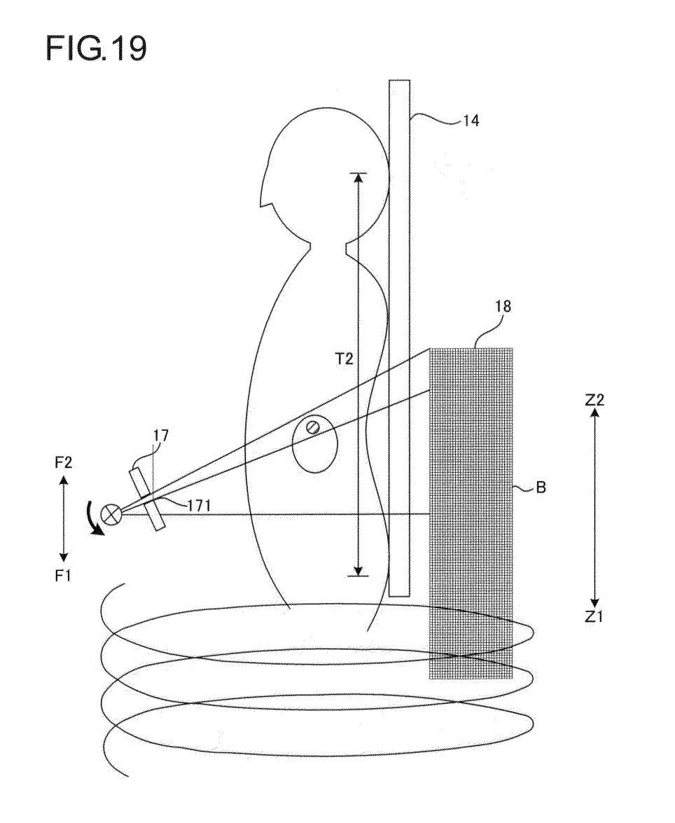

Next, the X-ray CT system 1 according to the fourth embodiment will be described with reference to FIG. 18 and FIG. 19. In said fourth embodiment, the configurations different from the above-described embodiments will be mainly described, with the same configurations provided with the same numbers and explanation thereof herein omitted.

The above-described embodiments described controllers (system controller 40 and scan controller 41) configured to control the collimator, thereby changing (switching) the size of the effective focal spot.

In said fourth embodiment, the controllers are configured such that the size of the effective focal spot is changed (switched) by means of integrally inclining the X-ray tube 16 and the collimator 17.

FIG. 18 illustrates CT scanning in which X-rays are irradiated from an effective focal spot of small size. As illustrated in FIG. 18, the X-ray detector 18 has a detection region configured by the X-ray detecting elements of even size. This detection region is positioned at the end near the anode in all detection regions, and this is referred to as the detection region near F1. This detection region may be of any size if the sizes of the X-ray detecting elements are even. The size of this detection region may be equivalent to, for example, any size of detection regions A to D according to the above-described embodiments.

The controller controls the collimator 17 such that the X-rays are irradiated from the effective focal spot of small size positioned near the anode onto detection region B near F1. In FIG. 18, the controllers incline the X-ray tube 16 and collimator 17 clockwise in FIG. 18 so as to make the size of the effective focal spot small. Since the X-rays are irradiated from the effective focal spot of small size onto detection region B near F1, it is possible to improve the resolution of the projection data obtained through CT scanning, and for example, it is possible to clarify the nebular shadow of the lungs (the nebular shadow is illustrated in FIG. 18 with hatching).

Further, the CT scan illustrated in FIG. 18 is not limited to the helical scanning of irradiating the X-rays while moving the top 14; however, this CT scan may be defined as helical scanning. For example, the entire range of the lungs (“T1” shown in FIG. 18) may be imaged.

FIG. 19 illustrates CT scanning in which X-rays are irradiated from an effective focal spot of large size. As illustrated in FIG. 19, here, detection region B is positioned at the end near the cathode in all detection regions, and this is referred to as the detection region near F2. In FIG. 19, the controllers incline the X-ray tube 16 and collimator 17 counter-clockwise in FIG. 19 so as to make the size of the effective focal spot large. Since the X-rays are irradiated from the effective focal spot of large size positioned near the cathode onto detection region B near F2, it is possible to reduce any noise from the projection data obtained through CT scanning and clarify the differences in concentration of images. For example, it is possible to clarify the CT shadow of a liver (the shadow in shown in FIG. 19 with hatching).

In the same way, assuming that the CT scan illustrated in FIG. 19 is helical scanning, for example, by imaging the range from the head to the crural area (“T2” shown in FIG. 19), it may be possible to diagnose displacement of a lesion, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of embodiments described herein may be made without departing from the spirit of the inventions. The accompanying claims and their equivalents are intended to cover such forms or modifications as would fall within the scope and spirit of the inventions.

What is claimed is:

1. An X-ray CT system configured to irradiate X-rays having a cone angle onto a subject such that they spread from an X-ray tube while rotating the X-ray tube and an X-ray detector around the subject mounted on top, and obtain projection data based on the X-rays transmitted through the subject and detected by the X-ray detector, comprising:
a collimator configured to limit the irradiation range of the X-rays for the subject, and
a controller configured to control said collimator,
wherein said X-ray tube has an emission surface of the X-rays, and said X-ray tube is configured such that the size of an effective focal spot that is the apparent size of the emission surface when the emission surface is observed from the side in which X-rays are irradiated is made smaller at one end of the cone angle, while the size of the effective focal spot is made to become increasingly larger toward other end of the cone angle, and
said controller is configured to select the effective focal spot with any size from small to large by controlling the collimator.

2. The X-ray CT system according to claim 1, wherein, further, said controller controls said collimator in accordance with the conditions that the X-rays are irradiated.

3. The X-ray CT system according to claim 1, wherein, further, said controller is configured to be capable of switching an effective focal spot from the effective focal spot of arbitrary size from said small size to said large size to an effective focal spot with a size different from said arbitrary size by controlling said collimator.

4. The X-ray CT system according to claim 3, wherein, further, said controller switches said effective focal spot by integrally inclining said X-ray tube and said collimator.

5. The X-ray CT system according to claim 3, wherein said X-ray detector has at least two ranges divided, and
further, said controller is configured to be capable of switching the irradiation range of the X-rays from the irradiation range in which the X-rays are irradiated from the effective focal spot of said small size to one of said two ranges to the irradiation range in which the X-rays are irradiated from the effective focal spot of said large size to said other range of said two ranges by controlling said collimator.

6. The X-ray CT system according to claim 1, wherein said X-ray detector has at least two ranges divided,
one range has a small detection range in which the X-ray detecting elements of small size for detecting the X-rays irradiated from the effective focal spot of small size at said one end side are arranged,
another range has a large detection range in which X-ray detecting elements of large size for detecting the X-rays irradiated from the effective focal spot other than said effective focal spot of small size at said other end side are arranged,
said large detection range is configured such that the size of the X-ray detecting element becomes increasingly larger from near the small detection range in the direction away therefrom, and
said controller is configured to be capable of switching the irradiation range of the X-rays in which the X-rays are irradiated from the effective focal spot of small size to the small detection range, in which the X-rays are irradiated from the effective focal spot of large size to the large detection range by controlling said collimator.

7. The X-ray CT system according to claim 1, further comprising a reconstructing means for reconstructing images from said projection data,
wherein said controller controls said reconstructing means to reconstruct images based on the first projection data obtained when the X-rays are irradiated from said effective focal spot of small size, and/or the second projection data obtained when the X-rays are irradiated from said effective focal spot of large size.

8. The X-ray CT system according to claim 7, wherein, further, said controller controls said collimator such that said limitation is released, and
further, said controller controls said reconstructing means to release said limitation and reconstruct images using third projection data obtained when the X-rays are irradiated onto said small detection range and said large detection range.

9. The X-ray CT system according to claim 8, wherein, further, said controller controls said reconstructing means to reconstruct images from the projection data obtained when the X-rays are irradiated onto said small detection range in said third projection data.

10. The X-ray CT system according to claim 1, wherein said system is configured to move said top in the rostrocaudal direction of said subject when said X-rays are irradiated while rotating said X-ray tube and said X-ray detector around said body axis.

11. A control program of the X-ray CT system configured to move the top in the rostrocaudal direction while rotating the X-ray tube and the X-ray detector oppositely arranged across the body axis of the subject mounted on the top around the body axis, and irradiate the X-rays onto the subject such that they spread from the X-ray tube in the rostrocaudal direction,
wherein said control program causes a computer embedded in said X-ray CT system to realize functions comprising the functions of:
causing the X-ray detector to detect the X-rays irradiated from the effective focal spot of small size of the X-ray tube onto the small detection range in which the X-ray detecting elements of small size are arranged, and cause the X-ray detector to detect the X-rays irradiated from the effective focal spot of large size onto the large detection range in which the X-ray detecting elements of large size are arranged,
obtaining third projection data based on the X-rays detected by said small detection range and said large detection range,
reconstructing images using said third projection data, and
reconstructing images from the projection data obtained based on the X-rays detected by said small detection range in said third projection data.
